(19) United States
(12) Patent Application Publication
(10) Pub. No.: US 2009/0134704 A1
(43) Pub. Date: May 28, 2009

(54) ELECTRIC POWER-SUPPLY APPARATUS AND OVER-DISCHARGE CONTROL METHOD FOR USE THEREWITH

(75) Inventor: Yuichi Utsumi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/324,391

(22) Filed: Nov. 26, 2008

(30) Foreign Application Priority Data
Nov. 27, 2007 (JP) 2007-305371

(51) Int. Cl. H02J 9/00

(52) U.S. Cl. 307/66

(57) ABSTRACT

A method for controlling over-discharge of a secondary battery that is charged with electric power from a main power supply and that supplies electric power to a load when the supply of electric power to the load by the main power supply is stopped is provided. When a battery voltage detection unit detects that the voltage output by the secondary battery has decreased to less than an auxiliary voltage threshold value, a switching unit sets the second electric power-supply unit, the load, and the auxiliary voltage detection unit to a disconnected state in which electric power is not supplied from the second electric power-supply unit to the load and the auxiliary voltage detection unit, and otherwise sets them to a connected state in which electric power is supplied from the secondary battery to the load and the battery voltage detection unit.

### BACKGROUND OF THE INVENTION

1. Field of the Invention

The present invention relates to an electric power-supply apparatus and an over-discharge control method for use with the electric power-supply apparatus.

2. Description of the Related Art

Secondary batteries, such as lithium batteries and nickel-metal-hydride batteries, are used as backup power supplies (auxiliary power supplies) when a main power supply (examples of main power supplies include a commercial power supply (AC power supply)) supplying electric power to the main body of a system, an apparatus, and the like is cut off.

It is known that, when these secondary batteries fall into an “over-discharge state” in which electrical current is continued to be discharged even when the charging capacity of a battery is decreased, the performance thereof markedly deteriorates.

Circuits that prevent this over-discharge so as to protect secondary batteries have hitherto been used (see, for example, Japanese Patent Laid-Open Nos. 3-74135 and 7-147733).

A protection circuit disclosed in Japanese Patent Laid-Open No. 3-74135 is configured in such a manner that a main power supply and a secondary battery are connected to each other, and an opening/closing device is disposed between a load and the secondary battery. When the voltage of the secondary battery is decreased to less than a fixed voltage, the opening/closing device is placed in a disconnected state, thereby preventing over-discharge of the secondary battery.

In Japanese Patent Laid-Open No. 7-147733, it is disclosed that a switching element is provided between a secondary battery and a load, so that when a detection circuit that detects the voltage of the secondary battery detects that the secondary battery has decreased to less than a fixed voltage, the switching element is turned off. Furthermore, if the decrease in the voltage of the secondary battery progresses, the detection circuit is disconnected from the secondary battery, so that electric power is not supplied from the secondary battery to the detection circuit.

However, in the over-discharge prevention circuit of Japanese Patent Laid-Open No. 3-74135, when over-discharge protection operates, a connection between a main power supply and a load is disconnected by an opening/closing device disposed between the main power supply and the load. For this reason, even if the main power supply is restored to a state in which electric power can be supplied to the load, electric power is not supplied to the load, and it is necessary to manually restore the connection between the main power supply and the load.

In the over-discharge prevention circuit of Japanese Patent Laid-Open No. 7-147733, it is necessary to have two switching elements, namely, a switching element for cutting connection between a secondary battery and a load and a switching element for cutting connection between a secondary battery and a detection circuit for detecting the voltage of a secondary battery, resulting in a complex configuration and high cost.

### SUMMARY OF THE INVENTION

The present invention provides an improved electric power-supply apparatus and an over-discharge control method for use with the electric power-supply apparatus.

Regarding over-discharge of a second electric power-supply unit for supplying electric power to a load in accordance with an auxiliary power supply, it is possible to prevent both over-discharge due to a load and over-discharge due to an auxiliary voltage detection unit for detecting a voltage output by the second electric power-supply unit. Furthermore, the present invention provides an electric power-supply apparatus for automatically restarting supply of electric power to a load on the basis of an external power supply in response to the restoration of a first electric power-supply unit for supplying electric power to the load, and an over-discharge control method for use with the electric power-supply apparatus.

As many different embodiments of the present invention can be made without departing from the spirit and scope thereof, it is to be understood that the invention is not limited to the specific embodiments thereof described in the detailed description.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate numerous embodiments, features and aspects of the invention and, together with the description, serve to explain the principles of the invention.

FIG. 1 is a system block diagram showing an example of the configuration of a system having an electric power-supply apparatus to which over-discharge control according to an embodiment of the present invention is applied.

FIG. 2 is a block diagram showing an example of the configuration of an electric power-supply apparatus 100 to which over-discharge control according to an embodiment of the present invention, shown in FIG. 1, is applied.

FIG. 3 shows an example of the configuration of a battery voltage detection unit 103 shown in FIG. 2.

FIG. 4 is a flowchart illustrating an over-discharge control method for use with an electric power-supply apparatus.

FIG. 5 is a flowchart showing a secondary battery voltage monitoring method shown in S304 and S308 of FIG. 4.

FIG. 6 is a flowchart illustrating a restoring method after over-discharge is cut off in the electric power-supply apparatus according to an embodiment of the present invention.

FIG. 7 is a flowchart illustrating a method for backing up a load (memory (DRAM)) 105.

### DETAILED DESCRIPTION OF THE EMBODIMENTS

The present invention will now be described in detail with reference to the drawings showing various embodiments thereof. In the drawings, elements and parts which are the same throughout the views are designated by the same reference numerals, and duplicate description thereof is omitted.

### Description of System Configuration

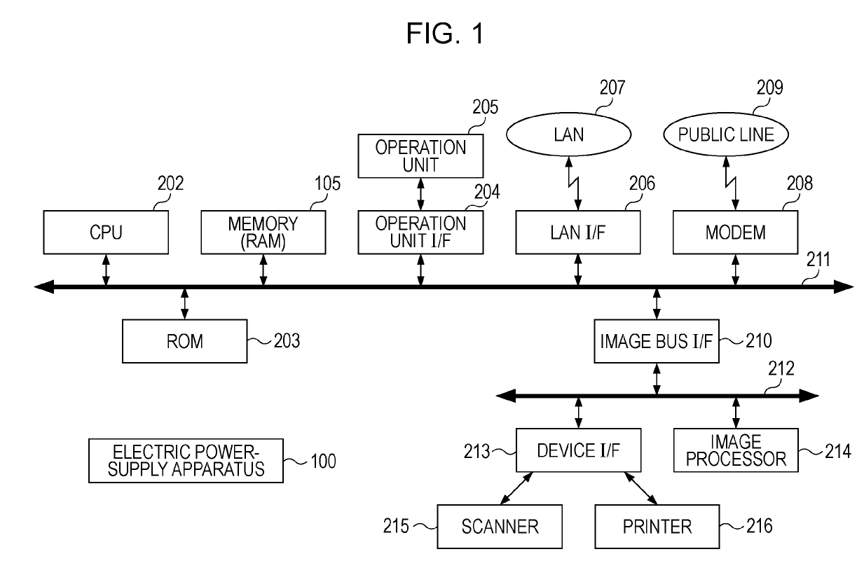

FIG. 1 is a system block diagram showing an example of the configuration of a system having a power-supply apparatus to which an over-discharge control apparatus according to an embodiment of the present invention is applied.

The present embodiment describes a case in which a secondary battery is used as an auxiliary power supply for backing up a volatile memory inside the system.

Specific examples of the system described in the present embodiment include a facsimile device, an MFP (Multi Function Peripheral/Multi Function Printer), and a digital multifunction device. Optionally, these examples may include a non-volatile storage device (a hard disk drive, a semiconductor disc drive, etc.)

With reference to FIG. 1, the system configuration will be described below.

In FIG. 1, reference numeral 202 denotes a CPU, which functions as a controller for controlling the entire system. Reference numeral 105 denotes a RAM, which is a system work memory used by the CPU 202 to operate, and which is also used as an image memory for temporarily storing image data. In this example, the RAM 105 is a volatile memory (DRAM) with a self-refresh function and can shift to a self-refresh mode in response to the instructions from the CPU 202 or the like. In the self-refresh mode, the RAM 105 is capable of holding the stored content with electric power lower than that during normal operation.

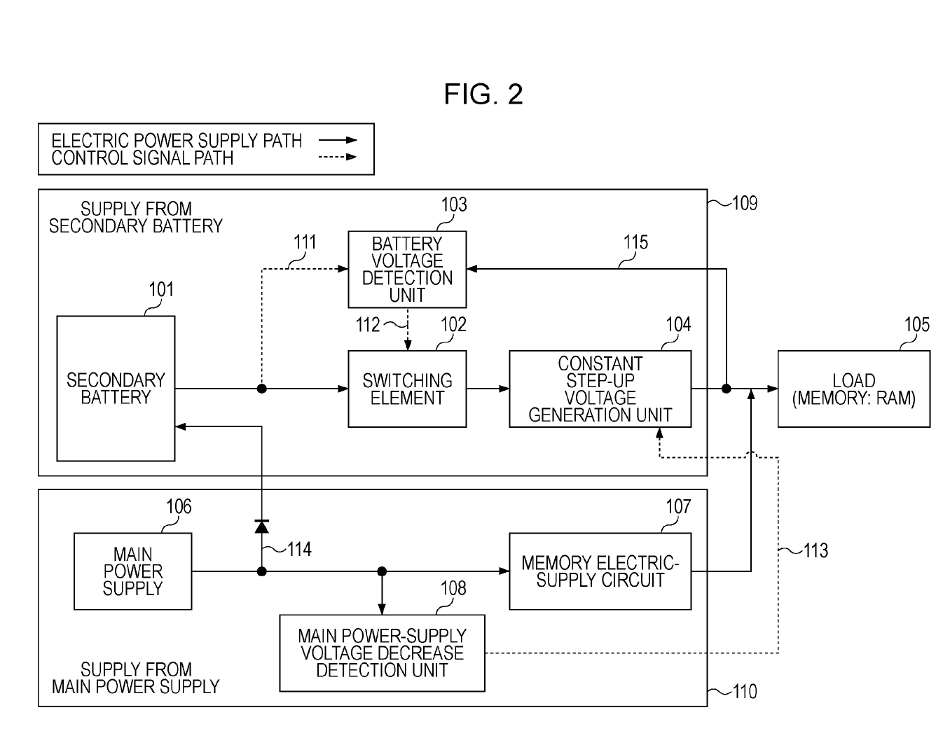

In the present embodiment, the RAM 105 becomes a target for which power supply backup (to be described later) is performed. Reference numeral 100 denotes an electric power-supply apparatus to which over-discharge control of the present invention is applied, and the electric power-supply apparatus 100 supplies electric power to each device of the system. The electric power-supply apparatus 100 will be described in detail with reference to FIG. 2 (to be described later).

Reference numeral 203 denotes a ROM, which functions as a boot ROM, in which the boot program of the system is stored. Reference numeral 204 denotes an operation unit I/F, which functions as an interface with an operation unit (UI) 205, and which outputs, to the operation unit 205, image data to be displayed on the operation unit 205. Also, the operation unit I/F 204 serves to transmit information input by a user of this system from the operation unit 205 to the CPU 202.

Reference numeral 206 denotes a network interface (LAN I/F), which is connected to a LAN 207 so as to perform input/output of information. Reference numeral 208 denotes a modem (MODEM), which is connected to a public line 209 so as to perform input/output of information. The above-described devices are arranged in a system bus 211, and information is transmitted and received via the system bus 211.

Reference numeral 210 denotes an image bus interface (Image Bus I/F), which is a bus bridge that connects the system bus 211 to an image bus 212 through which image data is transferred at high speed and which converts data structure.

Reference numeral 212 denotes an image bus composed of a high-speed bus, such as a PCI bus. In the image bus 212, devices (to be described later) are arranged.

Reference numeral 213 denotes a device I/F unit that connects a scanner 215 and a printer 216, which are image input/output devices, to the image bus 212, so that synchronous/asynchronous conversion of image data is performed. Reference numeral 214 denotes an image processor, which performs correction, processing, and editing on input image data and performs, for example, correction and resolution conversion for a printer.

### Description of Configuration for Backing Up Load (Volatile Memory (RAM) 105)

Next, a description will be given, with reference to FIG. 2, a configuration according to an embodiment of an over-discharge control apparatus of the present invention.

FIG. 2 is a block diagram showing an example of the configuration of an electric power-supply apparatus 100 to which over-discharge control of the present invention, shown in FIG. 1, is applied.

In FIG. 2, the solid-line arrow indicates a power supply path, and the dashed-line arrow indicates a control signal path. The respective configurations and functions thereof will be described below.

In FIG. 2, reference numeral 101 denotes a secondary battery used as an auxiliary power supply for which a charging/discharge cycle is possible. The secondary battery 101 receives electric power from the main power supply 106 and is charged. When the supply of electric power to the load (memory (RAM)) 105 by the main power supply 106 is stopped, the secondary battery 101, in place of the main power supply 106, supplies electric power to the load 105.

The secondary battery 101 (second electric power-supply unit) supplies electric power to a constant step-up voltage generation unit (stepping-up unit) 104 via the switching element (SW) 102. The constant step-up voltage generation unit 104 has a function of increasing the voltage of (stepping-up) the electric power supplied from the secondary battery 101 in accordance with the power-supply voltage of the load (memory (RAM 105)). For example, electric power in the range of approximately 1.0 to 1.5 V may be stepped-up to the range of approximately 2.5 to 2.6 V.

For the switching element (SW) 102, in general, a switching element, such as a field-effect transistor (FET), a transistor, or a relay, is used. The opening/closing of the circuit of the switching element 102 is performed in accordance with a SW ON/OFF signal 112. The SW ON/OFF signal is output by the battery voltage detection unit (auxiliary voltage detection unit) 103. The switching element 102 disconnects and connects the circuit between the secondary battery 101 and the load 105 in response to the instructions from the battery voltage detection unit 103.

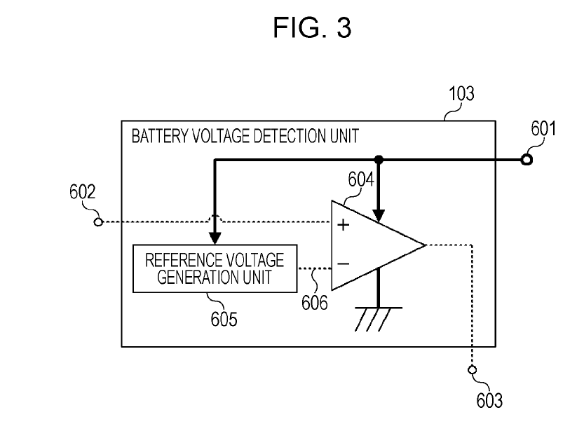

The battery voltage detection unit 103 (auxiliary voltage detection unit) is driven on the basis of load electric power (memory electric power 115) supplied to the load (volatile memory (RAM) 105). The battery voltage detection unit 103 monitors the output voltage of the secondary battery 101 so as to detect whether or not the output voltage of the secondary battery 101 is less than an auxiliary voltage threshold value (for example, less than 1.0 V), and switches the SW ON/OFF signal 112 on the basis of the detection result. When the battery voltage detection unit 103 detects that the output voltage of the secondary battery 101 is less than the auxiliary voltage threshold value, the battery voltage detection unit 103 causes the switching element 102 to disconnect the circuit between the secondary battery 101 and the load. On the other hand, when the battery voltage detection unit 103 does not detect that the output voltage of the secondary battery 101 is less than the auxiliary voltage threshold value, the battery voltage detection unit 103 causes the switching element 102 to connect the circuit between the secondary battery 101 and the load. The detailed configuration of the battery voltage detection unit 103 will be described in detail with reference to FIG. 3.

The memory electric power 115 generated by the constant step-up voltage generation unit 104 is supplied to the RAM 105, which is a volatile memory, which has shifted to a self-refresh mode. The constant step-up voltage generation unit 104 starts up or stops in accordance with a step-up power supply ON/OFF signal 113 (to be described later). When the main power supply 106 is shut down (when the supply of electric power to the main power supply 106 is cut off), in response to the step-up power supply ON/OFF signal 113, the constant step-up voltage generation unit 104 is controlled to begin to be driven (starts up) and is controlled to be stopped when the supply of electric power to the main power supply 106 is restored. The details of this control will be described in detail below.

The main power supply (first electric power-supply unit) 106 is a power supply that supplies electric power to the system (apparatus), shown in FIG. 1, and generates a DC voltage on the basis of an AC voltage supplied from a commercial power supply (external power supply) in the case of examples of a facsimile device, an MFP, a digital multifunction device, and the like.

The main power supply 106 is connected to the secondary battery 101 via a load power-supply circuit (memory power-supply circuit 107), the main power-supply voltage decrease detection unit (main power-supply voltage decrease detection unit) 108, and a rectifying diode 114.

The memory power-supply circuit 107 is in charge of generating memory electric power 115 while the main power supply 106 is supplying electric power.

The main power-supply voltage decrease detection unit 108 (main voltage detection unit) monitors the voltage value of the voltage output from the main power supply 106. When the supply of electric power from the main power supply 106 to the secondary battery 101 and the memory power-supply circuit 107 is cut off and the main power-supply voltage decrease detection unit 108 detects that the voltage value output from the main power supply 106 has decreased to less than a main voltage threshold value (for example, 2.9 V with respect to 3.3 V during normal operation), the state of the step-up power supply ON/OFF signal 113 output to the constant step-up voltage generation unit 104 is changed.

The operation of the constant step-up voltage generation unit 104 will be described below.

Usually, when the electric power-supply apparatus 100 is being used, electric power is supplied from the main power supply 106 to the memory power-supply circuit 107, and the memory electric power 115 is supplied from the memory power-supply circuit 107 to the load (memory (DRAM)) 105.

At this time, since the power-supply voltage during normal use is output by the main power supply 106, the main power-supply voltage decrease detection unit 108 detects the power-supply voltage during normal use as the voltage output from the main power supply 106. When it is not detected that the voltage output from the main power supply 106 has decreased in this manner, the main power-supply voltage decrease detection unit 108 outputs, as a step-up power supply ON/OFF signal 113, a signal (reset release signal) for turning off the constant step-up voltage generation unit 104. This signal causes the constant step-up voltage generation unit 104 to enter a non-operating state.

On the other hand, when the supply of electric power from the main power supply 106 to the secondary battery 101 and the memory power-supply circuit 107 is cut off for some reason, the voltage output from the main power supply 106 is decreased. At this time, the main power-supply voltage decrease detection unit 108 detects that the voltage output from the main power supply 106 has decreased. When it is detected that the voltage output from the main power supply 106 to the secondary battery 101 and the memory power-supply circuit 107 has decreased in this manner, the main power-supply voltage decrease detection unit 108 outputs a signal (reset signal) for turning on the constant step-up voltage generation unit 104, as a step-up power supply ON/OFF signal 113, before the memory electric power output from the memory power-supply circuit 107 is cut off. As a result, the constant step-up voltage generation unit 104 enters an operating state. With such a construction, even when the supply of electric power from the main power supply 106 to the secondary battery 101 and the memory power-supply circuit 107 is cut off due to power stoppage, it is possible to be switched to the supply of electric power from the secondary battery 101 without cutting off the supply of electric power to the load (memory (DRAM) 105).

While electric power is being supplied from the main power supply 106 to the secondary battery 101 and the memory power-supply circuit 107, by causing the operation of the constant step-up voltage generation unit 104 to be stopped, the discharge path of the secondary battery 101 is cut off and also, electric power is supplied from the main power supply 106 to the secondary battery 101 via the rectifying diode 114 so as to perform charging.

The rectifying diode 114 rectifies electrical current in a direction from the main power supply 106 to the secondary battery 101. When electric power is not supplied from the main power supply 106, the discharge electrical current from the secondary battery 101 does not flow to the main power supply 106 side.

Reference numeral 109 denotes an electric power-supply circuit for supplying electric power to the RAM 105 on the basis of the electric power supplied from the secondary battery 101. Reference numeral 110 denotes an electric power-supply circuit for supplying electric power to the RAM 105 on the basis of the electric power supplied from the main power supply 106. As described above, the memory electric power 115 supplied to the battery voltage detection unit 103 is supplied from the main power supply 106 when the main power supply 106 is in an ON state and is supplied from the secondary battery 101 when the main power supply 106 is in an OFF state. Although not shown in the figure, the main power supply 106 supplies electric power to each device shown in FIG. 1.

### Configuration of Over-Discharge Control for Secondary Battery

A description will be given below, with reference to FIGS. 2 and 3, of a configuration for preventing over-discharge in a secondary battery and of operations thereof. Here, a description will be given in more detail of a case in which the supply of electric power from the main power supply 106 to the secondary battery 101 and the memory power-supply circuit 107 is cut off and electric power is supplied from the secondary battery 101 to the load (memory (DRAM)) 105.

When the secondary battery 101 is fully charged, electric power is supplied from the secondary battery 101 to the constant step-up voltage generation unit 104 through the switching element 102.

Examples of types of the secondary battery 101 include a nickel-metal-hydride secondary battery. The voltage of the nickel-metal-hydride secondary battery during discharge is approximately 1.2 to 1.5 V. The constant step-up voltage generation unit 104 steps up (increases the voltage) the voltage output by the secondary battery in step with the power-supply voltage (approximately 2.5 V in the self-refresh mode of the DDR SDRAM) of the load (memory (DRAM)).

On the other hand, the battery voltage detection unit 103 operates on the basis of the stepped-up memory electric power 115 and monitors (detects) the voltage output by the secondary battery 101. Here, the details of the battery voltage detection unit 103 will be described with reference to FIG. 3.

FIG. 3 shows an example of the configuration of the battery voltage detection unit 103 shown in FIG. 2.

As shown in FIG. 3, the battery voltage detection unit 103 includes a regulator 605 serving as a reference voltage generation unit and a comparator 604. The regulator 605 and the comparator 604 operate on the basis of the memory electric power 115 supplied from the circuit power supply 601.

The regulator 605 generates a reference voltage 606 on the basis of the memory electric power 115 (that is, electric power supplied to the load 105) supplied from the circuit power supply 601.

The comparator 604 compares the output voltage (the battery voltage signal 111) of the secondary battery 101 supplied from a terminal 602 with the reference voltage 606. The comparator 604 outputs the comparison result as a high/low signal from a terminal 603. The high/low signal output from the terminal 603 is input, as a SW ON/OFF signal 112 for controlling the opening/closing of the switching element 102, to the switching element 102.

When the supply of electric power from the secondary battery 101 continues, the output voltage is decreased as a consequence of a decrease in the electrical current capacity of the secondary battery 101. When the voltage decrease is detected by the battery voltage detection unit 103 and the battery voltage signal 111 becomes less than a fixed voltage (1.0 V as an auxiliary voltage threshold value), the SW ON/OFF signal 112 is changed from a high state to a low state, causing the switching element 102 to be disconnected. In the present embodiment, for the switching element 102, a switching element is used that enters a conduction state (ON: connected state) when the SW ON/OFF signal 112 is high and enters a cut-off state (OFF) when it is low.

When the circuit of the switching element 102 becomes a closed state (OFF), since the supply of electric power to the constant step-up voltage generation unit 104 is cut off, the memory electric power 115 supplied from the circuit power supply 601 is cut off.

Furthermore, when the supply of electric power from the secondary battery 101 to the secondary battery 101 and the memory power-supply circuit 107 is cut off, the supply of electric power to the battery voltage detection unit 103 is also cut off, and the output signal SW ON/OFF signal 112 from the battery voltage detection unit 103 changes from high to low.

In the manner described above, since the connection of the secondary battery 101 with a load is cut off by the switching element 102, it is possible to prevent the secondary battery 101 to fall into a state in which discharge is continued (over-discharge state). The secondary battery 101, in particular, the exemplified nickel-metal-hydride secondary battery, has characteristics such that the electrical current capacity markedly deteriorates if it is left in an over-discharge state. Therefore, if the charging is cut to a certain degree, it is necessary to disconnect the secondary battery 101 from the load in order to create a no-load state. The present configuration is a suitable configuration for the secondary battery 101.

When a nickel-metal-hydride secondary battery is used as the secondary battery 101, the output voltage in the nickel-metal-hydride secondary battery during discharge may be as low as approximately 1.2 to 1.4 V which ordinarily cannot be used as a power supply for ICs. As a consequence, the constant step-up voltage generation unit 104 becomes necessary as in this configuration.

### Description of Discharge Method

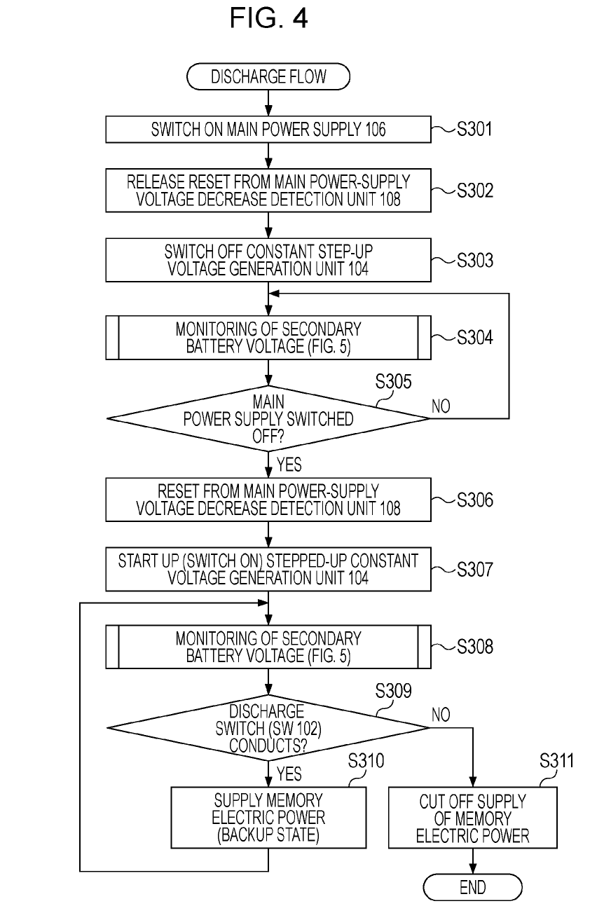

A description will be given below, with reference to FIG. 4, of a discharge method in the over-discharge control apparatus (electric power-supply apparatus) of the present invention.

FIG. 4 is a flowchart illustrating a discharge method in the over-discharge control apparatus of the present invention.

When the system is during normal use, the main power supply 106 is in an ON state (S301 to S302). When the main power supply 106 is in an ON state (S301), the main power-supply voltage decrease detection unit 108 does not detect a decrease in the voltage of the main power supply 106. In this case, the main power-supply voltage decrease detection unit 108 outputs a reset release signal as a step-up power supply ON/OFF signal 113 to be output to the constant step-up voltage generation unit 104 (S302) so as to control the operation of the constant step-up voltage generation unit 104 to be turned off (brought into a non-operating state). Upon receipt of this reset release signal, the constant step-up voltage generation unit 104 enters a non-operating (OFF) state (S303).

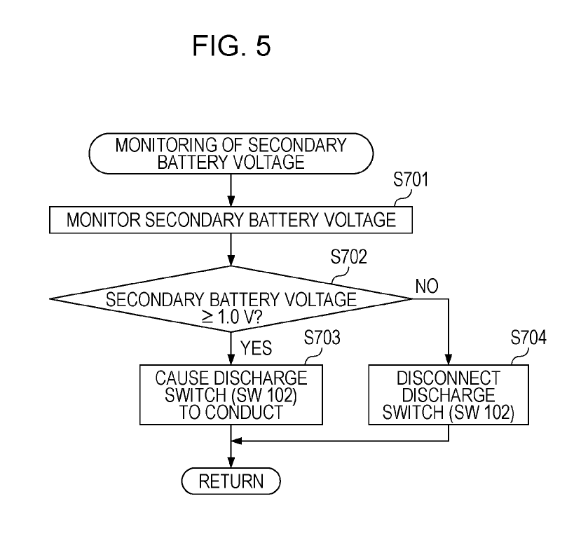

When the main power supply 106 is in an ON state, electric power (memory electric power 115) is supplied from the main power supply 106 to the battery voltage detection unit 103, causing the battery voltage detection unit 103 to be operated. The battery voltage detection unit 103 monitors the output voltage (the battery voltage signal 111) of the secondary battery 101, and controls the opening/closing (ON/OFF) of the switching element 102 (the monitoring of the secondary battery (S304)). The details of the monitoring of the secondary battery voltage in S304 and S308 (described below) are shown in FIG. 5 (described below). The monitoring of the secondary battery voltage is performed as desired when the main power supply 106 is normally supplying electric power or when the main power supply 106 is disconnected and electric power is supplied from the secondary battery 101, as will be described below.

When the main power supply 106 is disconnected due to power stoppage or the like (Yes in S305), the main power-supply voltage decrease detection unit 108 detects this on the basis of the voltage output by the main power supply 106 having decreased to less than the main voltage threshold value. In this case, the main power-supply voltage decrease detection unit 108 outputs a reset signal as a step-up power supply ON/OFF signal 113 to be output to the constant step-up voltage generation unit 104 (S306). Upon receipt of this reset signal, the constant step-up voltage generation unit 104 shifts to an operating (ON) state (S307). Furthermore, the monitoring of the secondary battery voltage (S308) is continuously performed starting from S304.

At this time, when the output voltage of the secondary battery 101 is less than a fixed auxiliary voltage threshold value (1.0 V in FIG. 5), it is determined that the charging capacity of the secondary battery 101 is not sufficient, and the switching element 102 is controlled to be in an OFF (disconnected) state through the monitoring of the secondary battery voltage (S304 or S308). When the switching element 102 is in an OFF (disconnected) state (No in S309), the supply of electric power from the secondary battery 101 to the constant step-up voltage generation unit 104 is not performed. For this reason, the supply of electric power to the load (memory (RAM)) 105 and the battery voltage detection unit 103 is stopped (cut off) (a state in which the memory electric power 115 is 0 V is reached) (S311).

On the other hand, at this time, if the output voltage of the secondary battery is greater than or equal to the auxiliary voltage threshold value (1.0 V in FIG. 5), the switching element 102 is controlled to be in an ON (conduction) state through the monitoring of the secondary battery voltage (S304 or S308). When the switching element 102 is in an ON (conduction) state (Yes in S309), electric power is supplied from the secondary battery 101 to the constant step-up voltage generation unit 104, and the memory electric power 115 is supplied from the constant step-up voltage generation unit 104 to the load 105 and the battery voltage detection unit 103 (S310). As a result of the electric power from the constant step-up voltage generation unit 104 being supplied, the battery voltage detection unit 103 continually monitors the output voltage (the battery voltage signal 111) of the secondary battery 101 and controls the opening/closing (ON/OFF) of the switching element 102 (the monitoring of the secondary battery (S308)).

Then, if the output voltage of the secondary battery 101 becomes less than the auxiliary voltage threshold value (1.0 V in FIG. 5), it is determined that the charging capacity of the secondary battery 101 is exhausted and a state close to “empty” is reached, and the switching element 102 is controlled to be in an OFF (disconnected) state by the monitoring of the secondary battery voltage (S308). When the switching element 102 enters a disconnected state (No in S309), the supply of electric power (in a backup state) from the secondary battery 101 to the constant step-up voltage generation unit 104 is completed. For this reason, the supply of electric power to the load (memory (RAM)) 105 and the battery voltage detection unit 103 is stopped (cut off) (a state in which the memory electric power 115 is 0 V is reached) (S311).

Therefore, it is necessary for the user who uses the system (apparatus) introduced in the present embodiment to recognize that the backup of the load (the memory (DRAM)) 105 by the secondary battery 101 is completed when a fixed period is exceeded.

### Description of Secondary Battery Voltage Monitoring Method

FIG. 5 is a flowchart illustrating a secondary battery voltage monitoring method shown in S304 and S308 of FIG. 4.

The battery voltage detection unit 103 monitors the output voltage (the battery voltage signal 111) of the secondary battery 101 (S701) and compares the battery voltage signal 111 with a reference voltage 606 (a preset fixed voltage (threshold value)).

When the comparison result indicates that the battery voltage signal 111 is greater than or equal to the reference voltage 606 (Yes in S702), the battery voltage detection unit 103 sets the SW ON/OFF signal 112 to be output to the switching element 102 to be a high state. Upon receipt of the SW ON/OFF signal 112 in a high state, the switching element 102 (the discharge switch) is brought into a conductive state (S703).

On the other hand, if the comparison result indicates that the battery voltage signal 111 is less than the reference voltage 606 (No in S702), the battery voltage detection unit 103 sets the SW ON/OFF signal 112 to be output to the switching element 102 to be a low state. Upon receipt of the SW ON/OFF signal 112 in a low state, the switching element 102 (the discharge switch) enters a disconnected state (S704).

### Description of Restoring Method After Over-Discharge is Cut Off

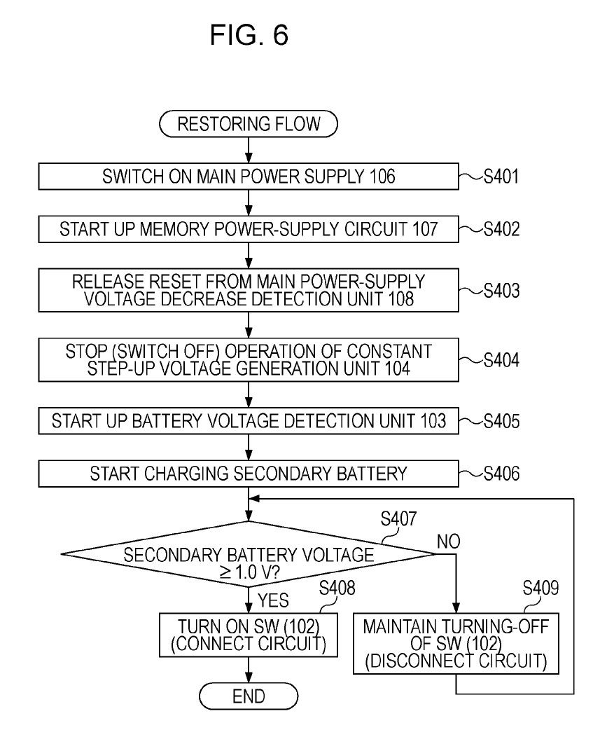

A description will be given below, with reference to FIG. 6, of operations in a case where, after a circuit is disconnected by the switching element 102 before an over-discharge state is reached as shown in FIG. 4, electric power to be supplied from the main power supply 106 to the secondary battery 101 and the memory power-supply circuit 107 is restored.

FIG. 6 is a flowchart illustrating a restoring method after over-discharge is cut off in the over-discharge control apparatus of the present invention.

When the electric power supplied from the main power supply 106 to the secondary battery 101 and the memory power-supply circuit 107 is restored (S401), the supply of electric power to the memory power-supply circuit 107 restarts (S402), and the memory power supply 115 restores to the voltage level of normal use.

At this time, the main power-supply voltage decrease detection unit 108 outputs a reset release signal as a step-up power supply ON/OFF signal 113 to be output to the constant step-up voltage generation unit 104 (S403) so as to control the operation of the constant step-up voltage generation unit 104 to be turned off (made not to operate). Upon receipt of this reset release signal, the constant step-up voltage generation unit 104 enters a stopped (OFF) state (S404).

When the memory electric power 115 is restored, the supply of electric power to the battery voltage detection unit 103 is restarted, and the battery voltage detection unit 103 is started up (S405). Then, the battery voltage detection unit 103 restarts the monitoring of the voltage of the secondary battery 101. Furthermore, the charging from the main power supply 106 to the secondary battery 101 is restarted (S406).

As a result of the monitoring of the output voltage of the secondary battery 101, while the output voltage of the secondary battery 101 is less than the reference voltage 606 (No in S407), the battery voltage detection unit 103 maintains the SW ON/OFF signal 112 output to the switching element 102 at low without change. For this reason, the circuit disconnected state (OFF state) of the switching element 102 is maintained without change (S409).

On the other hand, as a result of the monitoring of the output voltage of the secondary battery 101, when the output voltage of the secondary battery 101 becomes greater than or equal to the reference voltage 606 (Yes in S407), the battery voltage detection unit 103 changes the SW ON/OFF signal 112 output to the switching element 102 from low to high. Upon receipt of the SW ON/OFF signal 112 in a high state, the switching element 102 enters a conduction (circuit connected) state (S408). At this time, when the main power supply 106 is cut off again, as shown in steps S306 to S311 in FIG. 4, the supply of electric power from the secondary battery 101 begins, and backup and over-discharge protection operate.

### Description of Memory Electric Power Backup Method

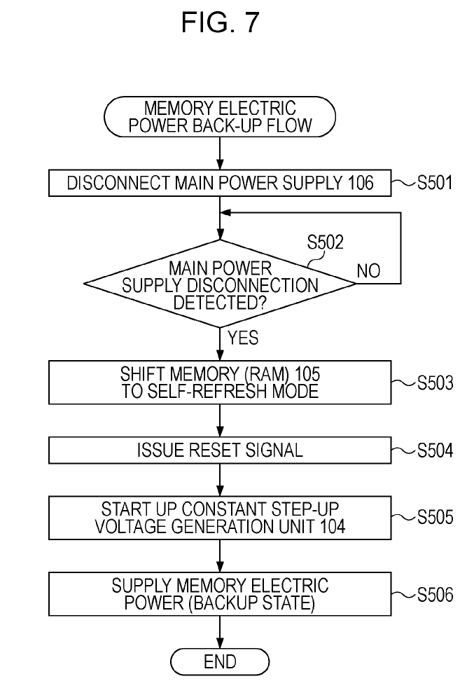

A description will be given below, with reference to FIG. 7, of the flow of a backup method for the load (memory (DRAM)) 105.

FIG. 7 is a flowchart illustrating a method of backing up the load (memory (DRAM)) 105. S502 and S503 correspond to steps that are implemented by the CPU 202 by reading and executing programs stored in the ROM 203.

When the supply of electric power from the main power supply 106 to the secondary battery 101 and the memory power-supply circuit 107 is cut off in the manner described above (S501) and the supply of electric power to the CPU 202 is decreased, the CPU 202 detects the cut off of the main power supply 106 (Yes in S502).

At this time, the CPU 202 issues, to the RAM 105, a command for causing the RAM 105 to shift to an operation mode, such as a self-refresh mode, in which stored content is held with electric power lower than that during normal operation (S503). Upon receipt of this command, the RAM 105 shifts to the self-refresh mode.

Next, the CPU 202 issues a command for issuing a reset signal to devices connected to the system (S504). Upon receipt of this command, the main power-supply voltage decrease detection unit 108 outputs a reset signal as the step-up power supply ON/OFF signal 113 to the constant step-up voltage generation unit 104. The main power-supply voltage decrease detection unit 108 may be configured to detect a decrease in the voltage of the main power supply 106 on its own and to output a reset signal. The main power-supply voltage decrease detection unit 108 may alternatively be configured to output a reset signal in response to the instructions from the CPU 202.

Thereafter, as a consequence of the supply of electric power from the main power supply 106 to the secondary battery 101 and the memory power-supply circuit 107 being cut off, upon receipt of the reset signal issued in S504, the constant step-up voltage generation unit 104 is initiated (enters an ON state) (S505). As a result, the supply of electric power from the secondary battery 101 begins (a backup state is reached) (S506).

As described in the foregoing, the over-discharge protection function in which the battery voltage detection unit 103 detects the termination voltage of the secondary battery 101 and disconnects the load 105 from the secondary battery makes it possible to prevent over-discharge of the secondary battery 101 due to the load 105. Furthermore, when the battery voltage detection unit 103 also uses the same electric power (the memory electric power 115) as that of the load 105 and the over-discharge protection function causes the switching element 102 to be disconnected so as to disconnect the load 105, the power supply to the battery voltage detection unit 103 is also cut off. This makes it possible to prevent the over-discharge of the secondary battery 101 by the battery voltage detection unit 103.

Even when over-discharge protection operates and the secondary battery 101 and the load 105 are disconnected from each other, if the main power supply 106 is restored, the supply of electric power from the main power supply 106 to the load 105 automatically restarts (without operation through human intervention). Furthermore, if the secondary battery 101 is fully charged, the secondary battery 101 and the load 105 are connected to each other, with the result that an advantage, such as automatically restoring to a state capable of backing up the load 105 from the secondary battery 101, can be realized with a simple configuration.

Furthermore, by providing the constant step-up voltage generation unit 104 immediately before the load 105, it is also possible to apply over-discharge control of the present invention to the secondary battery 101 having a low output voltage.

In addition, an advantage can be obtained such that, by turning on/off the constant step-up voltage generation unit 104 in accordance with a reset signal for the main power supply 106, it is possible to smoothly switch the supply of electric power between the main power supply 106 and the secondary battery 101.

In the present embodiment, a case in which the memory (RAM) 105 is backed up by the secondary battery 101 has been described as an example. However, a load to be backed up using the secondary battery 101 is not limited to a memory, and any load may be backed up.

Numerical values, such as the above-described various kinds of threshold values, are not limited to the specific values provided above, and may be structured by various structures and content according to applications and purposes.

The present invention may be applied to a system constituted by a plurality of devices or an apparatus constituted by a single device.

Many different embodiments of the present invention can be made without departing from the spirit and scope thereof. The invention is not limited to the specific embodiments thereof described above.

This application claims the benefit of Japanese Patent Application No. 2007-305371 filed Nov. 27, 2007, which is hereby incorporated by reference herein in its entirety.

What is claimed is:

1. An electric power-supply apparatus comprising:
a first electric power-supply unit configured to supply electric power to a load using an external power supply;
a second electric power-supply unit configured to be charged with electric power supplied from the first electric power-supply unit and configured to supply electric power to the load using an auxiliary power supply when supply of electric power to the load by the first electric power-supply unit is stopped;
an auxiliary voltage detection unit configured to operate using the electric power supplied from the first electric power-supply unit or the second electric power-supply unit and configured to detect a voltage output by the second electric power-supply unit; and
a switching unit configured to set, when the auxiliary voltage detection unit detects that the voltage output by the second electric power-supply unit has decreased to less than an auxiliary voltage threshold value, the second electric power-supply unit, the load, and the auxiliary voltage detection unit to a disconnected state in which electric power is not supplied from the second electric power-supply unit to the load and the auxiliary voltage detection unit, and configured to set, when the auxiliary voltage detection unit does not detect that the voltage output by the second electric power-supply unit has decreased to less than the auxiliary voltage threshold value, the second electric power-supply unit, the load, and the auxiliary voltage detection unit to a connected state in which electric power is supplied from the second electric power-supply unit to the load and the auxiliary voltage detection unit.

2. The electric power-supply apparatus according to claim 1, further comprising a voltage step-up unit which is disposed between the second electric power-supply unit and the load and which is configured to step up the voltage output by the second electric power-supply unit and to supply the voltage to the load.

3. The electric power-supply apparatus according to claim 2, further comprising a main voltage detection unit configured to detect a voltage output by the first electric power-supply unit,
wherein the voltage step-up unit is set to a non-operating state when the main voltage detection unit does not detect that the voltage output by the first electric power-supply unit has decreased to less than a main voltage threshold value, and the voltage step-up unit is set to an operating state when the main voltage detection unit detects that the voltage output by the first electric power-supply unit has decreased to less than the main voltage threshold value.

4. The electric power-supply apparatus according to claim 1, wherein the auxiliary voltage detection unit includes:
a reference voltage generation unit configured to generate a reference voltage using the electric power supplied by the first electric power-supply unit or by the second electric power-supply unit to the load; and
a comparison unit configured to compare the reference voltage generated by the reference voltage generation unit with the voltage output by the second electric power-supply unit to detect whether the voltage output from the second electric power-supply unit has decreased to less than the auxiliary voltage threshold value.

5. The electric power-supply apparatus according to claim 1, further comprising a rectifying unit configured to rectify electrical current from the first electric power-supply unit to the second electric power-supply unit, the rectifying unit provided between the first electric power-supply unit and the second electric power-supply unit.

6. The electric power-supply apparatus according to claim 1, wherein the load is a volatile memory, and
wherein the electric power-supply apparatus further comprises a control unit configured to set an operation mode of the memory to a mode in which stored content is held with electric power lower than that during normal operation when electric power is being supplied from the second electric power-supply unit to the memory.

7. An over-discharge control method for use with an electric power-supply apparatus including a first electric power-supply unit configured to supply electric power to a load using an external power supply, and a second electric power supply unit configured to be charged with electric power from the first electric power supply unit and configured to supply electric power to the load using an auxiliary power supply when supply of electric power to the load by the first electric power supply unit is stopped, the over-discharge control method comprising:
detecting a voltage output by the second electric power supply unit using an auxiliary voltage detection unit that operates using electric power supplied by the first electric power supply unit or by the second electric power supply unit; and
setting, when the auxiliary voltage detection unit detects that the voltage output by the second electric power supply unit has decreased to less than an auxiliary voltage threshold value, the second electric power-supply unit, the load, and the auxiliary voltage detection unit to a disconnected state in which electric power is not supplied from the second electric power-supply unit to the load and the auxiliary voltage detection unit, and setting, when the auxiliary voltage detection unit does not detect that the voltage output by the second electric power supply unit has decreased to less than the auxiliary voltage threshold value, the second electric power-supply unit, the load, and the auxiliary voltage detection unit to a connected state in which electric power is supplied from the second electric power-supply unit to the load and the auxiliary voltage detection unit.

8. The over-discharge control method according to claim 7, further comprising:
detecting a voltage output by the first electric power supply unit using a main voltage detection unit; and
setting a voltage step-up unit configured to step up the voltage output by the second electric power-supply unit and to supply the stepped-up voltage to the load to a non-operating state when the main voltage detection step does not detect that the voltage output by the first electric power supply unit has decreased to less than a main voltage threshold value, the voltage step-up unit disposed between the second electric power-supply unit and the load, and setting the voltage step-up unit to an operating state when the main voltage detection unit detects that the voltage output by the first electric power supply unit has decreased to less than the main voltage threshold value.

9. The over-discharge control method according to claim 7, wherein the load is a volatile memory, and
wherein the over-discharge control method further comprising setting an operation mode of the memory to a mode in which stored content is held with electric power lower than that during normal operation when electric power is being supplied from the second electric power supply unit to the memory.
